(19) United States
(12) Patent Application Publication
(10) Pub. No.: US 2019/0292979 A1
(43) Pub. Date: Sep. 26, 2019

(54) INTERCOOLER CONSISTING OF A LIQUID-COOLED PRECOOLER AND AN AIR-COOLED MAIN COOLER

(71) Applicant: Hanon Systems, Daejeon (KR)

(72) Inventors: Stepan Hlavac, Veseli nad Moravou (CZ); Hynek Hruza, Novy Jicin (CZ); Martin Bohac, Ostrava (CZ); Petr Kolder, Roznov pod Radhostem (CZ); Martin Sopuch, Zenklava (CZ)

(21) Appl. No.: 16/299,417

(22) Filed: Mar. 12, 2019

(30) Foreign Application Priority Data
Mar. 23, 2018 (DE) 102018106936.7

(51) Int. Cl. F02B 29/04; F28D 7/00; F28F 1/04; F28F 1/12

(52) U.S. Cl. CPC F02B 29/0412; F28D 7/0066; F02B 29/0437; F28F 1/12; F02B 29/0425; F28F 1/04

(57) ABSTRACT

An intercooler of a liquid-cooled precooler and an air-cooled main cooler. Between two distributor/collector units, disposed at end sides, with sealing plate several layers of flat tubes for charge air are disposed. Flat tubes in the region of the precooler are spaced apart in parallel via flat tubes for coolant of the precooler in thermal contact with the flat tubes and the flat tubes in the region of the main cooler are spaced apart in parallel via outer fins for cooling air. The precooler includes of several layers of flat tubes for coolant which form in the horizontal direction a U-shaped flow channel with an inlet zone, an onward-flow field, a deflection field, a return-flow field and an outlet zone for coolant. Inlet and outlet zones of individual layers of flat tubes are directly connected with one another in the vertical direction and disposed on one side on the intercooler.

The invention relates to an intercooler substantially structured of a liquid-cooled precooler and an air-cooled main cooler. The precooler is integrated into the intercooler and, together with the main cooler, forms a structural unit.

By intercooler is understood a heat exchanger which in the engine intake system of an internal combustion engine reduces the temperature of the combustion air supplied to the engine. By utilizing charge-air cooling in internal combustion engines the performance and the efficiency of the engine is increased.

However, under certain external conditions condensation may occur in the intercooler leading to misfiring and engine problems. Intercoolers are frequently not operated with full capacity for this reason. By precooling the charge air the problem of condensation in the intercooler can be counteracted.

Prior art discloses intercoolers with precoolers in various structural implementations.

In order to realize an especially efficient precooling, the precoolers are implemented as liquid-cooled and in particular as water-cooled heat exchangers, in which the charge air is precooled before it reaches the air-cooled intercooler and is cooled therein to the desired final temperature.

Apart from the implementation of the precoolers as separate heat exchangers, prior art also discloses attempts of integrating the precooler directly into the intercooler and therewith to attain a space-saving implementation.

EP 0 289 406 A1 discloses for example a two-stage heat exchanger and its assembly method, wherein the disclosed intercooler comprises a water-cooled precooler and an air-cooled aftercooler.

GB 2023797 A also discloses a combined water-cooled and air-cooled intercooler for internal combustion engines.

Improved combined intercoolers are disclosed in U.S. Pat. No. 7,165,537 B2 and EP 1 386 068 B1, in which a zone of the air-cooled heat exchanger is developed as collector and distributor with a liquid cooling across a tank. The liquid-cooled zone is herein placed as a separate precooler directly after the input of the charge air into the cooler.

EP 2 044 304 A1 furthermore discloses a heat exchanger with coupling connection, for example intercooler, and coupling connection for heat exchanger, which is equipped specifically for use as intercooler with combined air and liquid cooling. The precooler is herein integrated into a region of the heat exchanger. The precooler is developed of flat tubes connected with one another across distributor and collector. The flat tubes of the precooler extend in the interval between the flat tubes with the charge air, and cool the same.

The disadvantage inherent in the stated prior art is that the known design engineering structures are most often complex and the structural integration of the precooler is frequently not completely successful. Especially in the field of motor vehicle technology this represents a disadvantage since inside the vehicles there is a shortage of space and installation space for additional components is frequently not available.

The invention has as its objective to provide an intercooler which constructively forms a unit of main cooler and precooler integrated therein. A space-saving implementation with low pressure loss is herein to be realized.

The objective is attained through a subject matter with the characteristics according to patent claim 1. Further developments are specified in the dependent patent claims.

The problem of the invention is in particular resolved through an intercooler substantially comprised of a liquid-cooled precooler and an air-cooled main cooler. Between a distributor unit disposed at an end side and a collector unit, disposed on the other side at the end side, each provided with a cover plate, several layers of flat tubes for the charge air are disposed. In the region of the precooler the flat tubes for the charge air are thermally in contact with flat tubes for the coolants, that are spaced apart in parallel, wherein alternately flat tubes for the charge air and flat tubes for the coolants are arranged in several layers. The precooler is comprised of several layers of flat tubes for the coolant, wherein these flat tubes form in the horizontal direction a U-shaped flow channel in the plane with an inlet zone, an onward-flow field, a deflection field, a return-flow field and an outlet zone for the coolant. The inlet zone of flat tubes, disposed one above the other, for the coolant are disposed such that they are vertically aligned and connected with one another in the vertical direction such that these inlet zones of flat tubes, adjacent in the vertical direction, act as distributor for the coolant. Similarly, the outlet zones of the individual layers of the flat tubes for the coolant are likewise connected with one another in the vertical direction and act as collector. The inlet zones and outlet zones of the flat tubes are disposed on one side on the intercooler. The alignment of the flat tubes for the coolant is oriented transversely to the flat tubes for the charge air in the precooler such that a cross counterflow is generated. The deflection field of the precooler is preferably implemented to be flush with the flat tube for the charge air such that a highly space-saving architecture is generated. The deflection fields of the different flat tubes for the coolant that are opposite to the inlet and outlet zones are not connected with one another.

The precooler and the main cooler are advantageously delimited by one base plate and one cover plate.

In the vertical direction on the cover plate of the precooler are disposed the coolant inlet feedpipe and coolant outlet feedpipe such that the coolant flows on one side, preferably on the upper side, of the heat exchanger into the precooler and is conducted adjacently on the same side of the heat exchanger out of the precooler again. The placement of the connections on one side and in the vertical direction allows good manageability during assembly and disassembly.

It is especially preferred to dispose inner fins in the flat tubes for the charge air such that a continuous good thorough mixing and the excellent heat transfer entailed therein are ensured. The flat tubes for the coolant are similarly also equipped with inner fins which, however, are adapted to the coolant based on the specific conditions, in contrast to the implementation of fins through which air flows.

The flat tubes for the coolant are formed of two metal sheets connected in the margin area that are welded, soldered or crimped together at the margins.

It is especially advantageous for the distributor unit and the collector unit to be structurally identical since they can in this case be produced and employed especially efficiently.

It is preferred to utilize water as the coolant for the precooler.

Especially preferred is for the height of the flat tubes for the coolant to correspond to the height of the outer fins for the cooling air such that the flat tubes for the charge air can be placed and disposed in a straight line. In the region of the main cooler the outer fins for the cooling air are in contact with the flat tubes for the charge air, and in the region of the precooler the flat tubes for the coolant are in contact with the flat tubes for the charge air.

The advantages of the invention reside especially in a cost-efficient construction that is highly material saving as well as in a lesser installation size of the intercooler. A further advantageous effect comprises a decrease in the number of components and tools in comparison to separate precoolers.

It is especially advantageous that the pressure drop in the precooler is especially low in comparison to external precoolers or the known integrated precoolers.

The concept of the invention comprises that the liquid-cooled heat exchanger core with the coolant-conducting flat tubes of the precooler is disposed alternatingly between the charge air heat exchanger flat tubes, and in this way an especially intensive heat transfer can take place during the precooling at a relatively low temperature.

With this integrated solution a good compromise between performance, pressure drop and heat exchanger cost has been reached in comparison to separate heat exchangers for precooling and main cooling.

Further details, characteristics and advantages of embodiments of the invention are evident in the following description of embodiment examples with reference to the associated drawing. Therein show:

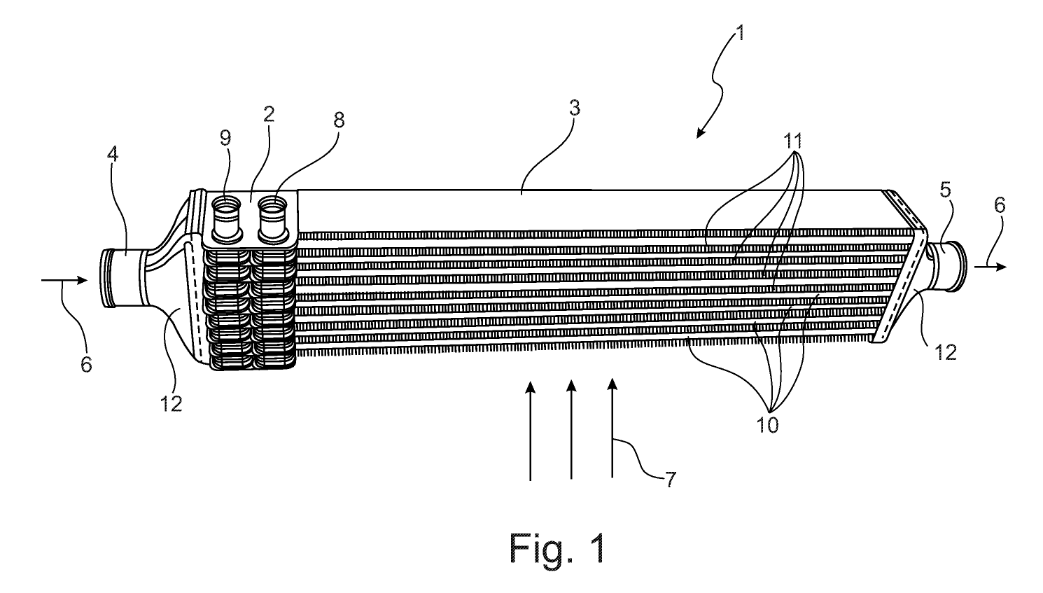

FIG. 1: intercooler in perspective representation,

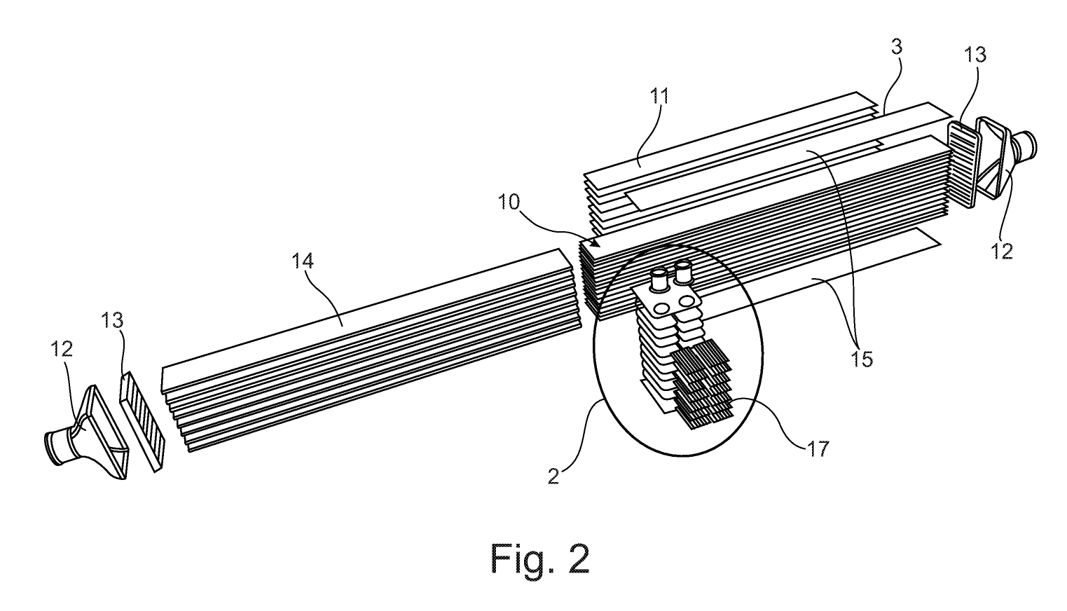

FIG. 2: intercooler in exploded representation,

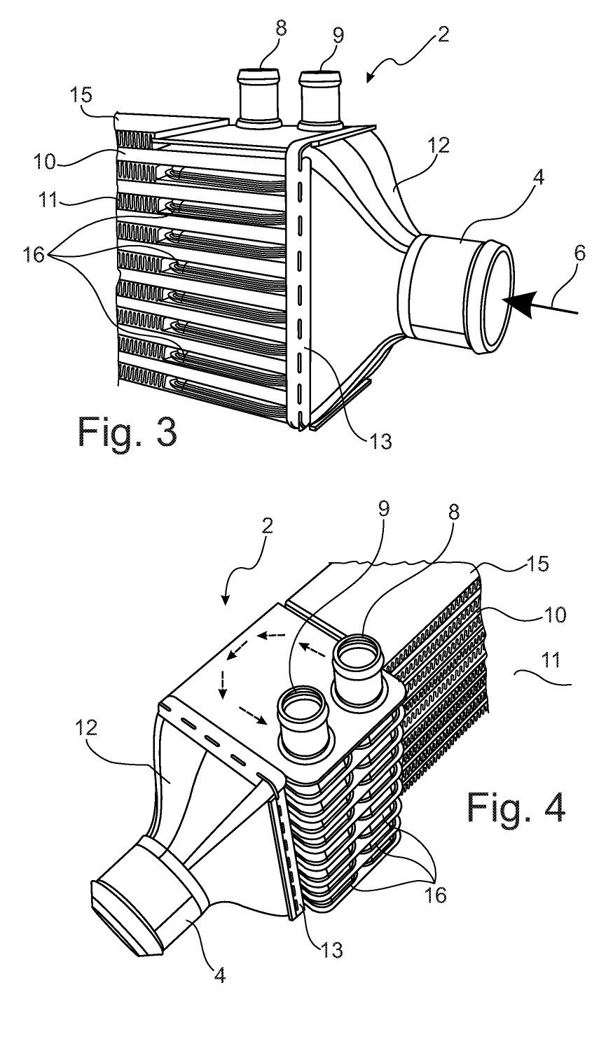

FIG. 3: precooler of the intercooler in perspective view from the back,

FIG. 4: precooler of the intercooler in perspective view from above,

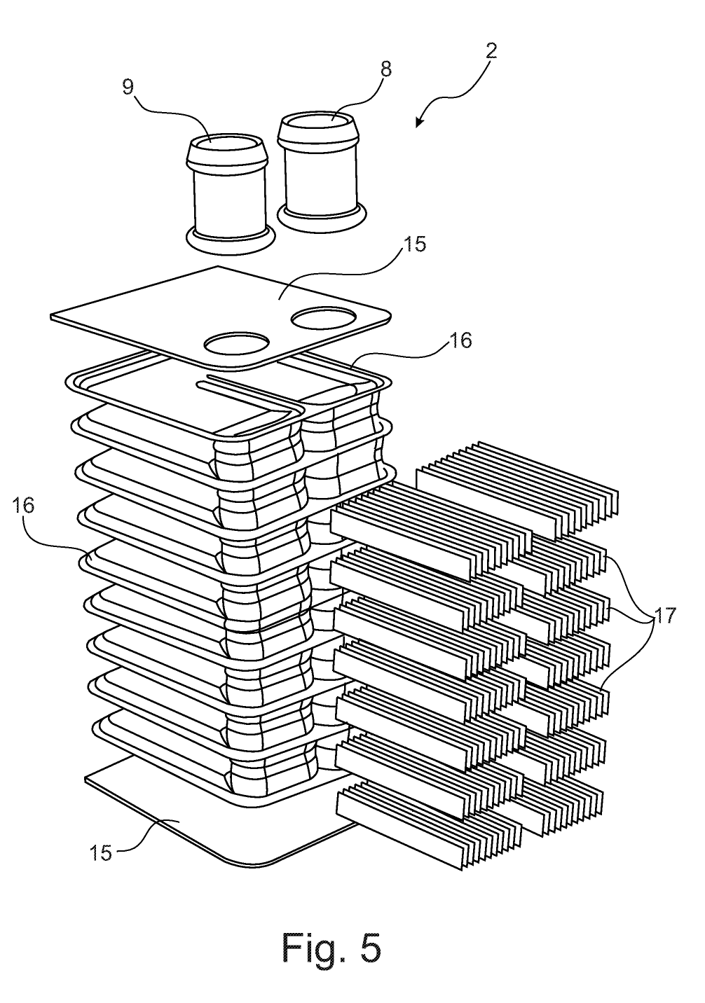

FIG. 5: precooler in exploded view,

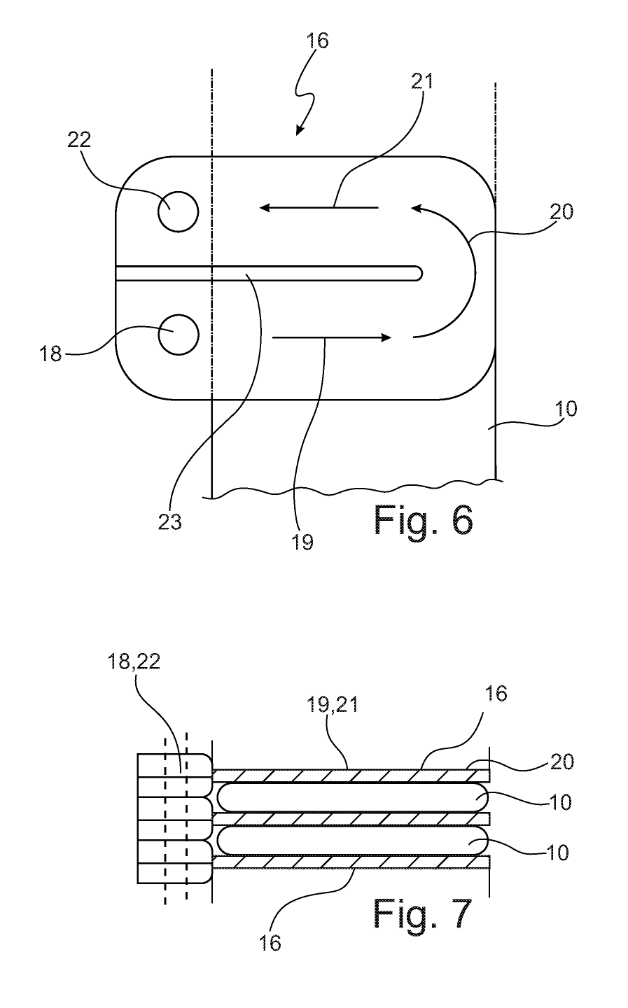

FIG. 6: flat tube for coolant in plan view with section in the horizontal direction, and

FIG. 7: flat tubes in several layers for coolant in longitudinal section.

In FIG. 1 is depicted an intercooler 1 substantially comprised of an inflow zone, a precooler 2, a main cooler 3 and an outflow zone for the charge air 6. The charge air 6 flows through a charge air inlet feedpipe 4 into the distributor unit 12 and from here through the flat tubes 10 integrated into the distributor unit 12 with a sealing plate 13. The charge air 6 subsequently flows through the flat tubes 10. The flat tubes 10 extend over the entire length of the intercooler 1, from the distributor unit 12 on the one side up to the collector unit 12 on the other side of the intercooler 1. The outlet of the charge air 6 leaves the intercooler 1 through the charge air outlet feedpipe 5. Consequently, the intercooler 1 is delimited at the end side by the distributor/collector unit 12. In the region of the precooler 2 the charge air 6 is cooled by coolant which flows via the coolant inlet feedpipe 8 into the precooler 2 and is conducted through the coolant outlet feedpipe 9 out of it again. The coolant inlet and outlet feedpipes 8, 9 are oriented in the vertical direction. In the region of the main cooler 3 the flat tubes 10 for the charge air 6 are cooled by cooling air 7 which flows through the interspaces between the flat tubes 10, indicated by arrows. In the interspaces between the flat tubes 10 for the charge air 6 outer fins 11 for the cooling air 7 are disposed which improve the heat transfer on the cooling air side.

In FIG. 2 a depiction of the intercooler 1 is shown in exploded view in which the individual components, as have already been described and shown in FIG. 1, can again be seen in a different representation. The not visible components, such as for example the inner fins 14 for the charge air 6 and also the inner fins 17 for the coolant are additionally shown.

The advantageous uniform implementation of the distributor/collector unit 12 at both sides as well as the integration of the flat tubes 10 across a sealing plate 13 into the distributor/collector unit 12 leads to a structurally simple configuration of the intercooler 1, which is of advantage with respect to costs.

The precooler 2 is disposed in the proximity directly following the inlet of the charge air into the flat tubes 10 and cools the charge air flowing into the flat tubes 10. A base/cover plate 15 delimits the main cooler 3.

The inner fins 14 for the charge air are located in the flat tubes 10 and improve the heat transfer from the charge air to the flat tube shell. The flat tubes 10 discharge the heat to the outer fins 11 around which flows the cooling air.

FIG. 3 shows the precooler 2 of the intercooler in a perspective back view. The charge air 6, as indicated by the direction arrow, flows through the charge air inlet feedpipe 4 into the distributor unit 12. The distributor unit 12 expands the flow cross section in the manner of a diffuser from the charge air inlet feedpipe 4 up to the cross section of the tube packet of flat tubes 10. Integration of the flat tubes 10 for the charge air 6 into the distributor unit 12 takes place via the sealing plate 13 which functionally also realizes the sealing of the charge air flow toward the outside. In the region of the precooler 2 the flat tubes 10 for the charge air are in thermal contact with the flat tubes 16 for the coolant of the precooler 2. The flat tubes 16 for the coolant are of a height which corresponds to the height of the outer fins 11 for the cooling air and thus fit in between the flat tubes 10 for the charge air.

Between the flat tubes 10 for the charge air 6 and the flat tubes 16 for the coolant heat conductive paste is preferably disposed for the improvement of the heat transfer. The heat exchanger packet of the precooler 2 is also delimited at the end side by a, not shown, base plate and a depicted cover plate 15.

The coolant in the region of the precooler 2 flows through the coolant inlet feedpipe 8 into the precooler 2 and out of it again through the coolant outlet feedpipe 9, wherein the offset of coolant inlet feedpipe 8 and coolant outlet feedpipe 9 in the longitudinal direction of the intercooler, in combination with the flow within the flat tubes 16 for the coolant, leads to a cross counterflow of the coolant with respect to the charge air.

In FIG. 4 is shown the precooler 2 of the intercooler in a perspective view from above. Supplementing the depiction according to FIG. 3, in FIG. 4 the flow path of the coolant within the precooler 2 is indicated by arrows in dashed lines. FIG. 4 furthermore shows that the zone of the inflow and outflow for the coolant is placed laterally on the intercooler and projects minimally beyond it.

On the other side of precooler 2 the flat tube 16 for the coolant is flush with the flat tubes 10 for the charge air 6.

FIG. 5 shows the precooler 2 in an exploded representation in an enlarged depiction compared to FIG. 2. The precooler 2 comprises substantially a heat exchanger core formed of flat tubes 16 for the coolant. The heat exchanger core is delimited at the upper side and the lower side by one base plate and one cover plate 15. In the cover plate 15 receptions for the coolant inlet feedpipe 8 and the coolant outlet feedpipe 9 are provided. Furthermore, inner fins 17 for the coolant are shown which are disposed in the flat tubes 16 for the coolant. These inner fins 17 for the coolant are specifically adapted to the application and do not form a major flow resistance within the flat tubes 16 for the coolant. Therewith a uniform temperature distribution of the coolant in the flat tubes 16 is achieved.

In FIG. 6 is depicted a flat tube 16 with its various functional domains. Indicated is the position of the flat tube 16 transversely to the course of the flat tubes 10 within the intercooler 1. The flow path of the coolant within the flat tube 16 is visualized in horizontal section and indicated by arrows. The coolant flows in the inlet zone 18 into the flat tube 16 and flows in an onward-flow field 19 along the flat tube 16 and therewith transversely to the flat tube 10 for the charge air. At the end of flat tube 16 the coolant flows in the deflection field 20, preferably in countercurrent to the charge air, in the flat tube 10 into the return-flow field 21, in which it is again guided transversely to the flat tube 10, reaching the outlet zone 22. This representation illustrates that the deflection field 20 of the flat tube 16 for the coolant is flush with the flat tube 10 for the charge air. On the side of the inlet zone 18 and of outlet zone 22, in contrast, flat tube 16 for the coolant is projecting beyond the flat tube 10.

In FIG. 7 lastly a longitudinal section through a layer packet of several layers of flat tubes 16 for the coolant is shown. In this depiction is evident that the inlet zone 18 and the outlet zone 22 are widened in the vertical direction such that the underside of a flat tube 16 is in contact with the upper side of an adjacent flat tube 16 and that they are connected with one another in the vertical direction. Through the direct connection of adjacent inlet zones 18 the coolant reaches all flat tubes 16 of the flat tube packet in parallel. The inlet zone 18 is consequently in the vertical direction simultaneously distributor zone for the coolant for the distribution of the coolant onto the individual flat tubes 16, as is indicated through a dotted connection line.

In the representation according to FIG. 7 the outlet zone 22 is located behind the inlet zone 18 in the projecting segment of the flat tube 16. The outlet zone 22 functions as collector zone, in which the coolant collected from the different planes from all flat tubes 16 is conveyed upwardly.

The implementation of the flat tubes 16 as being flush on one side with the flat tubes 10 and the minimal projection of the flat tubes 16 on the other side beyond the flat tubes 10 through the formation of the inlet zone 18 and the outlet zone 22 for the coolant, an especially space-saving formation of a precooler is achieved. The inlet zones 18 of superjacently disposed flat tubes 16 are simultaneously distributor zones for the coolant and the outlet zones 22 analogously thereto form a collector zone for the coolant.

The flat tubes 16 for the coolant are implemented according to a preferred embodiment of the invention of two profiled sheet metal sheets connected with one another in the margin areas by welding, soldering or crimping. The sheets, in the representation according to FIG. 7 shown in longitudinal section, are profiled such that one inlet zone and one outlet zone is stamped out in the vertical direction, wherein these zones of adjacent flat tubes 16 border on one another forming a seal toward the outside and in the interior enable a fluid passage for the coolant from one flat tube 16 to the adjacent flat tube 16 in the vertical direction. The metal sheets for the flat tubes 16 are profiled for the formation of the flow fields with a center wall 23 in FIG. 6 that extends from the side of the inlet and outlet zone 18, 22 up to the deflection field and consequently forms a flow guidance in the onward-flow field 19 and the return-flow field 21.

### LIST OF REFERENCE NUMBERS

1 Intercooler
2 Precooler
3 Main cooler
4 Charge air inlet feedpipe
5 Charge air outlet feedpipe
6 Charge air
7 Cooling air
8 Coolant inlet feedpipe
9 Coolant outlet feedpipe
10 Flat tube for charge air
11 Outer fins for cooling air
12 Distributor/collector unit
13 Sealing plate
14 Inner fins for charge air
15 Base/cover plate
16 Flat tube for coolant
17 Inner fins for coolant
18 Inlet zone
19 Onward-flow field
20 Deflection field
21 Return-flow field
22 Outlet zone
23 Center wall

1. An intercooler of a liquid-cooled precooler and an air-cooled main cooler, wherein between two distributor/collector units disposed at end sides with sealing plate several layers of flat tubes for charge air are disposed, wherein the flat tubes in the region of the precooler are spaced apart in parallel via flat tubes of the precooler in thermal contact with these flat tubes and that the flat tubes in the region of the main cooler are spaced apart in parallel via outer fins for cooling air wherein the precooler is developed of several layers of flat tubes for coolant, wherein the flat tubes form in the horizontal direction a U-shaped flow channel with an inlet zone, an onward-flow field, a deflection field, a return-flow field and an outlet zone for the coolant, wherein the inlet zones and the outlet zones of the individual layers of the flat tubes are directly connected with one another in the vertical direction and are disposed on one side on the intercooler and that the flat tubes for the coolant are disposed in the precooler in cross counterflow transversely to the flat tubes for the charge air.

2. An intercooler as in claim 1, wherein the deflection field of the precooler is flush with the flat tube for the charge air.

3. An intercooler as in claim 1, wherein the precooler and the main cooler are delimited by a base and a cover plate.

4. An intercooler as in claim 3, wherein on the cover plate of the precooler are disposed in the vertical direction the coolant inlet feedpipe and the coolant outlet feedpipe.

5. An intercooler as in claim 1, wherein inner fins are disposed in the flat tubes for charge air.

6. An intercooler as in claim 1, wherein inner fins are disposed in the flat tubes for coolant.

7. An intercooler as in claim 1, wherein the flat tubes for coolant are comprised of two sheet metal sheets connected in the margin areas.

8. An intercooler as in claim 1, wherein the distributor/collector unit is developed structurally identically.

9. An intercooler as in claim 1, wherein water can be utilized as the coolant.

10. An intercooler as in claim 1, wherein the height of the flat tubes for the coolant corresponds to the height of the outer fins for the cooling air.

11. An intercooler as in claim 2, wherein the precooler and the main cooler are delimited by a base and a cover plate.

12. An intercooler as in claim 11, wherein on the cover plate of the precooler are disposed in the vertical direction the coolant inlet feedpipe and the coolant outlet feedpipe.

13. An intercooler as in claim 2, wherein inner fins are disposed in the flat tubes for charge air.

14. An intercooler as in claim 3, wherein inner fins are disposed in the flat tubes for charge air.

15. An intercooler as in claim 4, wherein inner fins are disposed in the flat tubes for charge air.

16. An intercooler as in claim 2, wherein inner fins are disposed in the flat tubes for coolant.

17. An intercooler as in claim 3, wherein inner fins are disposed in the flat tubes for coolant.

18. An intercooler as in claim 4, wherein inner fins are disposed in the flat tubes for coolant.

19. An intercooler as in claim 5, wherein inner fins are disposed in the flat tubes for coolant.

20. An intercooler as in claim 2, wherein the flat tubes for coolant are comprised of two sheet metal sheets connected in the margin areas.
